(19) United States
(12) Patent Application Publication
(10) Pub. No.: US 2003/0155192 A1
(43) Pub. Date: Aug. 21, 2003

(54) Unidirectional adjustment mechanism for a disk used in a bicycle

(76) Inventor: Ming-Ta Tsai, Shu-Lin City (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/078,596

(22) Filed: Feb. 19, 2002

(51) Int. Cl. F16D 69/00

(52) U.S. Cl. 188/250 A; 188/250 R

(57) ABSTRACT

A unidirectional adjustment mechanism has an adjustment knob and a driving bolt screwingly connected to the adjustment knob and abutted by a right caliper body that is adapted to be secured to a left caliper body. Rotation of the adjustment knob can only drive the driving bolt in one direction due to the abutment of the right caliper body to the driving bolt, such that a brake lining attached to the driving bolt is able to be pushed toward the disk to enhance the brake effect.

### BACKGROUND OF THE INVENTION

1. Field of the Invention

The present invention relates to a unidirectional adjustment mechanism, and more particularly to a unidirectional adjustment mechanism for a disk used in a bicycle. The unidirectional adjustment mechanism has an adjustment knob and a driving bolt screwingly connected to the adjustment knob and abutted by a right caliper body that is adapted to be secured to a left caliper body. Rotation of the adjustment knob can only drive the driving bolt in one direction due to the abutment of the right caliper body to the driving bolt, such that a brake lining attached to the driving bolt is able to be pushed toward the disk to enhance the brake effect.

2. Description of Related Art

A conventional bicycle uses a brake drum that is normally mounted on the rear wheel axle to stop rotation of the rear wheel. Yet, due to the braking effect to the bicycle rear wheel being not as good as expected and the maintenance thereof is difficult due to the casing covering the outside of the brake drum, a new generation of brake is invented. The new generation bicycle brake adopts a disk brake mechanism instead of a drum to generate the necessary friction to stop the rotation of the wheel. The disk brake mechanism drives two brake pads to simultaneously clamp the disk so as to stop the rotation of the wheels.

A conventional disk brake assembly usually comprises two pairs of braking mechanisms, i.e., a first braking member related to the first braking pad and a second braking member concerning the second braking pad. With reference to FIGS. 7 and 8, a conventional first braking member (1) is secured to a fork of a bicycle and has a driving arm (11), a left caliper body (13), a spring (12) clamped between the driving arm (11) and the left caliper body (13), a driving shaft (15) with a rod (153) extending into the left caliper body (13) and a head (151) integrally formed with the rod (153), a pushing member (17) with a driven shaft (173) extending into the rod (153) from the head (151) and a disk (171) integrally formed with the driven shaft (173) and a first braking pad (19) abutted by the disk (171).

The driving arm (11) has a first through hole (110) defined to allow a threaded adjusting bolt (111) to extend therethrough. A distal end of the adjusting bolt (111) is screwingly connected to a lock nut (112) so as to secure the relative position of the adjusting bolt (111) in the driving arm (11). The driving arm (11) is pivotally engaged with the left caliper body (13). The left caliper body (13) has a second through hole (130) defined to allow the extension of the rod (153) of the driving shaft (15) and to receive the spring (12) therein. The driving shaft (15) further has multiple arcuate recesses (152) defined in a bottom face of the head (151) to receive therein balls (156). Accordingly, the balls (156) are securely received between the head (151) of the driving shaft (15) and the driving arm (11).

After the foregoing elements are assembled, it is to be noted that the pivotal movement of the driving arm (11) also drives the driving shaft (15) to pivot, which forces the balls (156) to move inside the arcuate recesses (152). The movement of the balls (156) forces the driving shaft (15) to move toward the pushing member (17). Therefore, the first braking pad (19) is pushed toward the disk (70) to eventually stop the rotation of the wheel of the bicycle.

This kind of movement of the first braking pad (19) is conventional in the art and well known to the person skilled in the art. When the first braking pad (19) is worn and an adjustment is necessary to amend the distance loss due to the wearing of the first braking pad (19), the user unscrews the locking nut (112) to have access to the adjusting bolt (111). Then, the user is able to adjust the relative position of the driving shaft (15) to the left caliper body (13). However, the adjustment is only applicable to the first braking pad (19), the second braking pad (29) can not be adjusted.

To overcome the shortcomings, the present invention tends to provide an improved unidirectional adjustment mechanism to mitigate and obviate the aforementioned problems.

### SUMMARY OF THE INVENTION

The primary objective of the present invention is to provide an improved unidirectional adjustment mechanism for a bicycle braking pad. With the unidirectional adjustment mechanism, the user is able to adjust the relative position of the second braking pad to the right caliper body.

In order to accomplish the foregoing objective, the unidirectional adjustment mechanism has an adjustment knob and a driving bolt screwingly connected to the adjustment knob and abutted by a right caliper body that is adapted to be secured to a left caliper body. Rotation of the adjustment knob can only drive the driving bolt in one direction due to the abutment of the right caliper body to the driving bolt, such that a brake lining attached to the driving bolt is able to be pushed toward the disk to enhance the brake effect.

Other objects, advantages and novel features of the invention will become more apparent from the following detailed description when taken in conjunction with the accompanying drawings.

### BRIEF DESCRIPTION OF THE DRAWINGS

FIG. 1 is a schematic perspective view showing the location of the unidirectional adjustment mechanism of the present invention;

FIG. 2 is an exploded perspective view of the unidirectional adjustment mechanism in FIG. 1;

FIG. 3 is a cross sectional view showing that the unidirectional adjustment mechanism is adapted to be secured to the left caliper body;

FIG. 4 is a cross sectional view showing that the unidirectional adjustment mechanism is adjusted by turning the adjustment knob;

FIG. 5 is a side plan view in partial section showing the relationship between the adjustment knob and the right caliper body;

FIG. 6 is a cross sectional view showing that two seals are provided in the first braking member to prevent damage to the left caliper body;

FIG. 7 is an exploded perspective view of a conventional first braking member to adjust the first braking pad; and

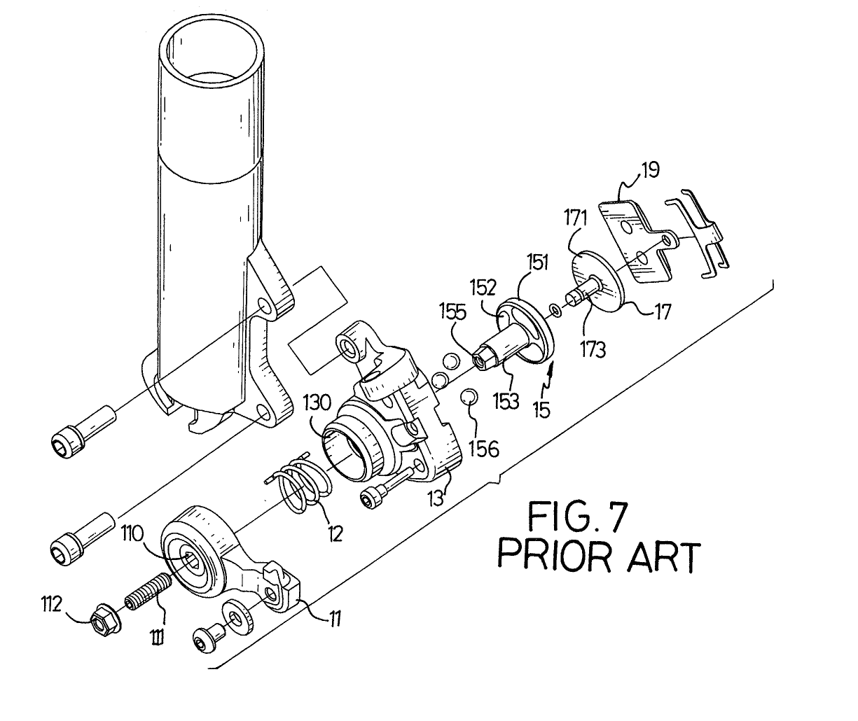

FIG. 8 is a cross sectional view showing the assembled first braking member and the adjustment to the first braking pad.

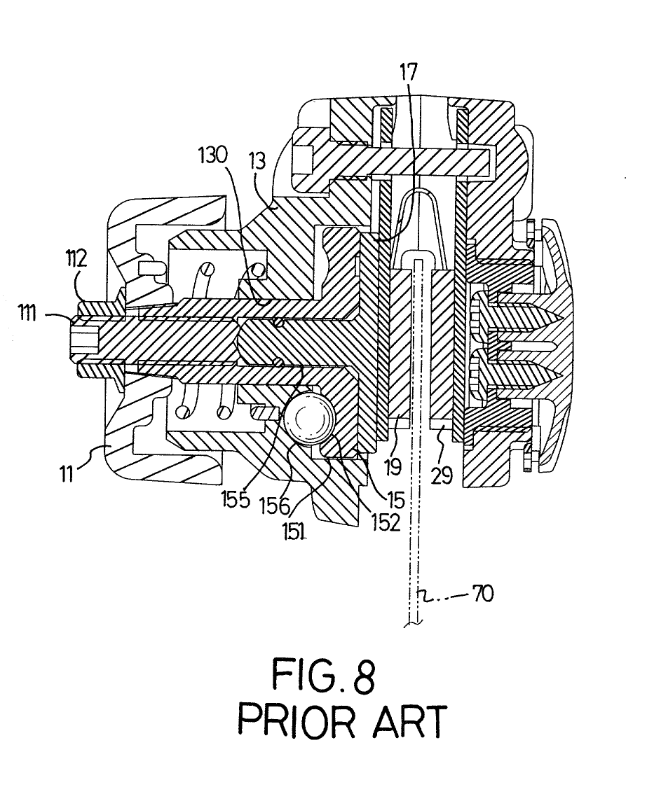

### DETAILED DESCRIPTION OF THE PREFERRED EMBODIMENT

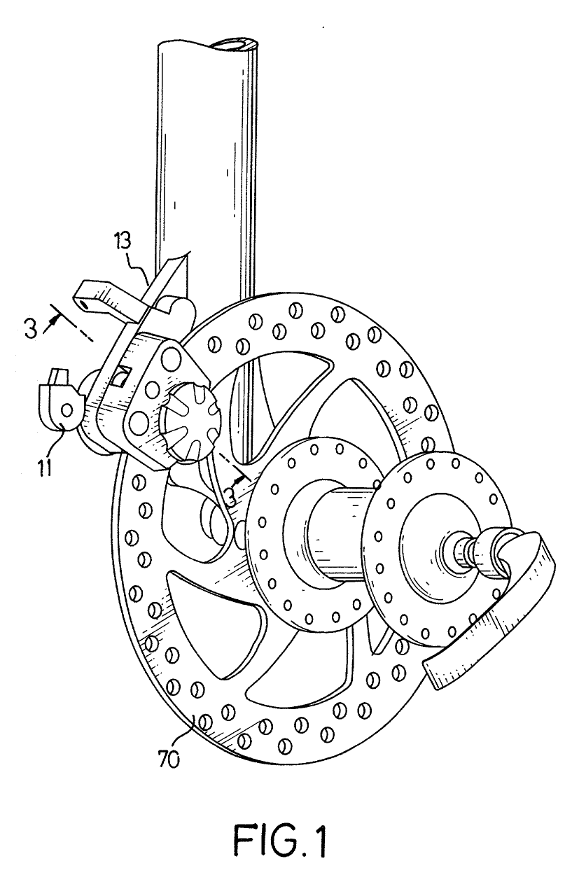

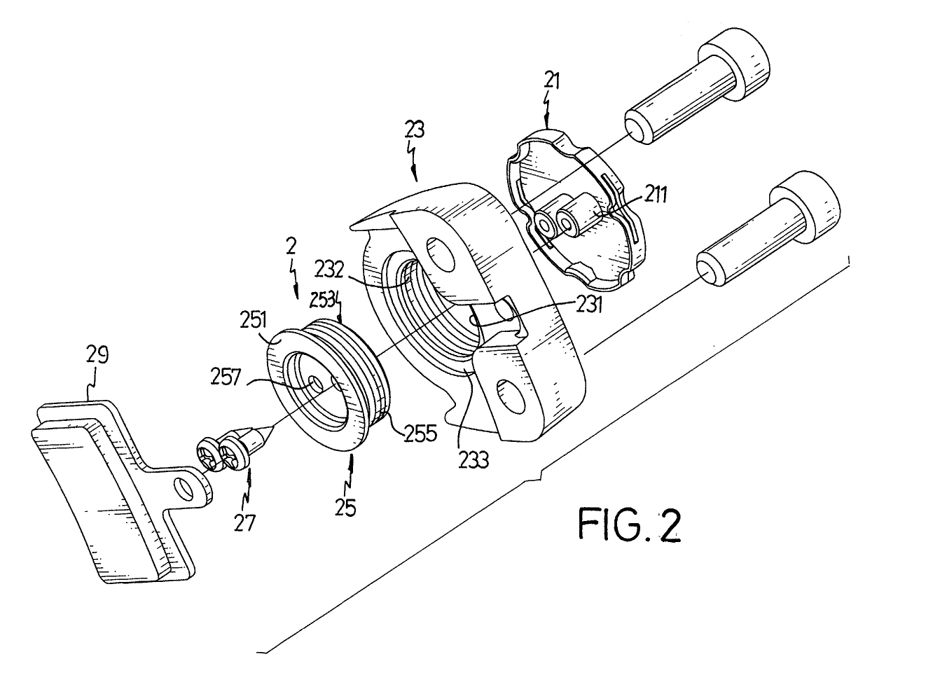

With reference to FIGS. 1, 2 and 3, it is to be noted that the unidirectional adjustment mechanism of the present invention is mounted on the left caliper body (13) which is pivotally connected to the head tube of a bicycle. The unidirectional adjustment mechanism (2) has an adjustment knob (21), a right caliper body (23), a driving bolt (25), a fastener, such as a pair of locking screws (27) in this preferred embodiment and a second braking pad (29).

The right caliper body (23) has two first holes (230) defined to align two second holes (not numbered) in the left caliper body (13) so that the right caliper body (23) is able to securely engage with the left caliper body (13) by means of locking bolts (not numbered). Further, the right caliper body (23) has a fourth through hole (231) provided with an inner thread (232) formed on a face defining the fourth through hole (231) and an annular recess (233) defined immediately adjacent to one edge of the fourth through hole (231).

The adjustment knob (21) has a pair of hollow extensions (211) formed on a rear face of the adjustment knob (21) to extend through the fourth through hole (231).

The driving bolt (25) has a flange (251) corresponding to the annular recess (233), a tube (253) integrally formed with the flange (251) and provided with an outer threading (255) to correspond to the inner threading (232) of the fourth through hole (231) and two locking holes (257) defined to correspond to the two hollow extensions (211). Whereby, the two locking screws (27) are able to extend through the two locking holes (257) and into the two hollow extensions (211) to secure the engagement among the driving bolt (25), the right caliper body (23) and the adjustment knob (21).

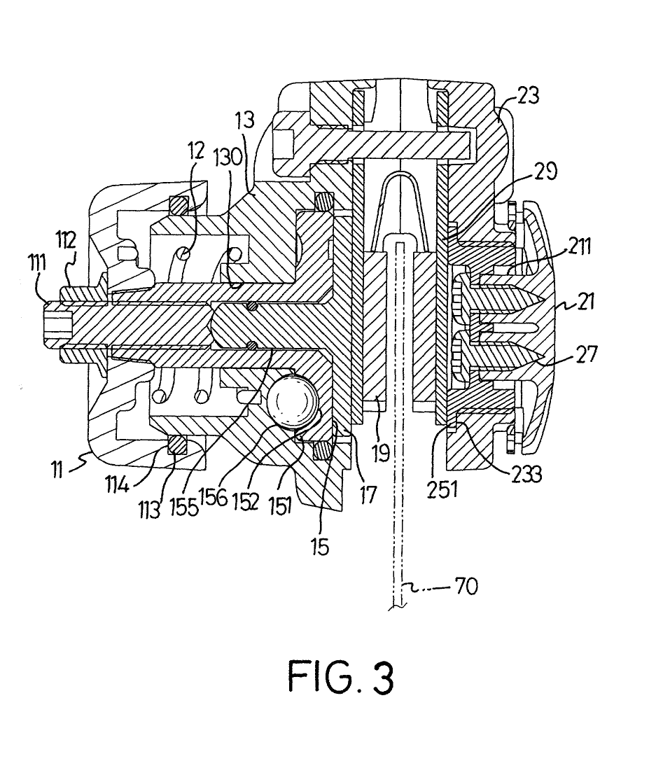

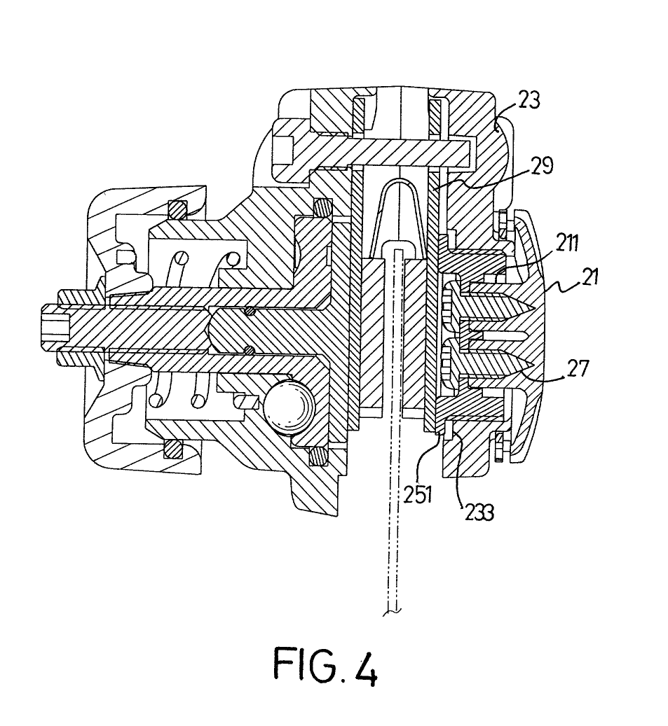

With reference to FIGS. 3 and 4, after the unidirectional adjustment mechanism of the present invention is assembled to the left caliper body (13) by bolts extending through the aligned pairs of the first holes (230) and the second holes, the flange (251) abuts the annular recess (233) and the driving bolt (25) is screwingly received inside the fourth through hole (231) of the right caliper body (23). Meantime, the adjustment knob (21) is securely connected to the driving bolt (25) by the pair of locking screws (27) and one side of the driving bolt (25) abuts the second braking pad (29).

Therefore, rotating the adjustment knob (21) triggers the simultaneous rotation of the driving bolt (25). However, due to the abutment of a bottom face of the annular recess (233) to the flange (251) of the driving bolt (25), the adjustment knob (21) can only rotate in one direction, which causes the driving bolt (25) to move in only one direction, i.e., to the second braking pad (29).

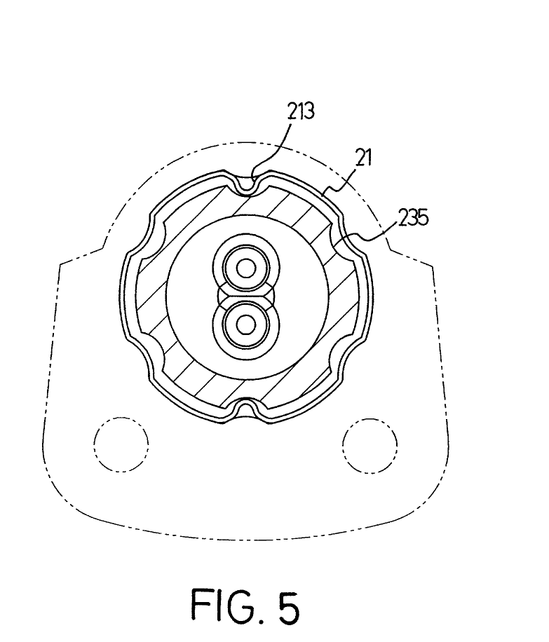

With reference to FIG. 5, the adjustment knob (21) further has multiple protrusions (213) and the right caliper body (23) has multiple notches (235) equally defined in an edge of the fourth through hole (231) to correspond to the protrusions (213) so that when the adjustment knob (21) is assembled with the right caliper body (23) and the adjustment knob (21) is rotated, each one of the protrusions (213) will slip over one of the notches (235) to function as an indication to the user of how much distance the driving bolt (25) has been adjusted by the rotation of the adjust knob (21).

With the arrangement as described above, the user is able to adjust not only the first braking pad (19), but also the second braking pad (29). By adjusting the distance of the first braking pad (19) to the disk (70) and the distance of the second braking pad (29) to the disk (70), the user is able to have much better braking effect when compared to the conventional braking mechanism.

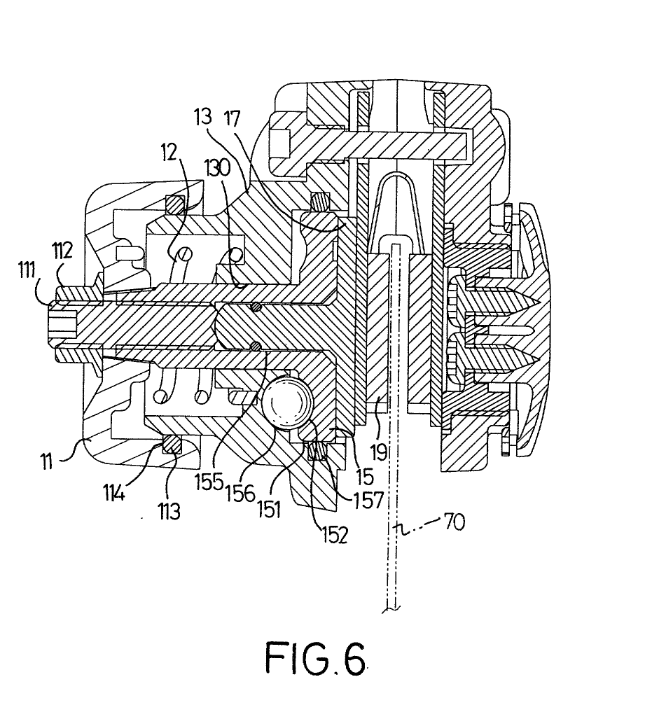

With reference to FIG. 6, it is noted that a first seal (113) is provided between the left caliper body (13) and the driving arm (11) which receives partially the left caliper body (13). A second seal (157) is provided between the driving arm (11) and the driving shaft (15). Thereby, after a part of the left caliper body (13) is received in the driving arm (11), the first seal (113) is received between the driving arm (11) and the received part of the left caliper body (13). Further, before the assembly between the driving arm (11) and the driving shaft (15), the second seal (157) is provided therebetween. Pollutant is effectively kept away from entering the left caliper body (13) and so prevents damage the parts inside the left caliper body (113).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A unidirectional adjustment mechanism for a disk brake for a bicycle having a left caliper body and a driving arm pivotally connected to the left caliper body, the unidirectional adjustment mechanism comprising:
a right caliper body adapted to be secured to the left caliper body and having a through hole defined through the right caliper body;
a driving bolt screwingly connected to the right caliper body;
an adjustment knob rotatably connected to the right caliper body and securely connected to the driving bolt; and
a braking pad securely engaged with the driving bolt, wherein the driving bolt is so configured that rotation of the adjustment knob drives the driving bolt to move in only one direction.

2. The unidirectional adjustment mechanism as claimed in claim 1, wherein the driving bolt has a tube extending into the through hole of the right caliper body and a flange integrally formed with the tube; and
wherein the right caliper body has an annular recess defined in one end of the through hole to correspond to the flange.

3. The unidirectional adjustment mechanism as claimed in claim 2, wherein the through hole has an inner threading and the tube has an outer threading corresponding to the inner threading so that the driving bolt is able to be screwingly connected to the right caliper body.

4. The unidirectional adjustment mechanism as claimed in claim 3, wherein the flange abuts the annular recess so as to allow the adjustment knob to rotate in one direction to move the position of the braking pad to a disk while the pad wears away.

5. The unidirectional adjustment mechanism as claimed in claim 1, wherein the driving bolt has two locking holes and the adjustment knob has two hollow extensions formed on a face of the adjustment knob to correspond to the two locking holes so that the driving bolt is able to securely engage with the adjustment knob by two locking screws extending through the two locking holes and into the two hollow extensions.

6. The unidirectional adjustment mechanism as claimed in claim 4, wherein the driving bolt has two locking holes and the adjustment knob has two hollow extensions formed on a face of the adjustment knob to correspond to the two locking holes so that the driving bolt is able to securely engage with the adjustment knob by two locking screws extending through the two locking holes and into the two hollow extensions.

7. The unidirectional adjustment mechanism as claimed in claim 2, wherein the adjustment knob has multiple protrusions and the right caliper body has multiple notches defined oppositely to the annular recess and correspond to the protrusions so as to function as an indication of how much distance the driving bolt has been pushed.

8. In a disk brake for a bicycle having a left caliper body secured to a head tube of a bicycle, a driving arm pivotally connected to the left caliper body, a driving shaft extending through the left caliper body and movable relative to the left caliper body, a first braking pad abutted by the driving shaft in such a manner that the first braking pad is movable relative to the left caliper body and a second braking pad assembly, wherein the improvements comprise:
a first seal provided between the driving arm and the left caliper body and a second seal provided between the driving arm and the driving shaft are able to prevent pollutant from entering the left caliper body.

9. The disk brake for a bicycle as claimed in claim 8, wherein the second braking pad assembly comprises:
a right caliper body adapted to be secured to the left caliper body and having a through hole defined through the right caliper body;
a driving bolt screwingly connected to the right caliper body;
an adjustment knob rotatably connected to the right caliper body and securely connected to the driving bolt; and
a braking pad securely engaged with the driving bolt, wherein the driving bolt is so configured that rotation of the adjustment knob drives the driving bolt to move in only one direction.

10. The unidirectional adjustment mechanism as claimed in claim 9, wherein the driving bolt has a tube extending into the through hole of the right caliper body and a flange integrally formed with the tube; and
wherein the right caliper body has an annular recess defined in one end of the through hole to correspond to the flange.

11. The unidirectional adjustment mechanism as claimed in claim 10, wherein the through hole has an inner threading and the tube has an outer threading corresponding to the inner threading so that the driving bolt is able to be screwingly connected to the right caliper body.

12. The unidirectional adjustment mechanism as claimed in claim 11, wherein the flange abuts the annular recess so as to allow the adjustment knob to rotate in one direction to push the braking pad to the disk.

13. The unidirectional adjustment mechanism as claimed in claim 9, wherein the driving bolt has two locking holes and the adjustment knob has two hollow extensions formed on a face of the adjustment knob to correspond to the two locking holes so that the driving bolt is able to securely engage with the adjustment knob by two locking screws extending through the two locking holes and into the two hollow extensions.

14. The unidirectional adjustment mechanism as claimed in claim 12, wherein the driving bolt has two locking holes and the adjustment knob has two hollow extensions formed on a face of the adjustment knob to correspond to the two locking holes so that the driving bolt is able to securely engage with the adjustment knob by two locking screws extending through the two locking holes and into the two hollow extensions.
